(19) United States
(12) Patent Application Publication
(10) Pub. No.: US 2010/0177899 A1
(43) Pub. Date: Jul. 15, 2010

(54) ENCRYPTED COMMUNICATION SYSTEM

(75) Inventors: Stephen Randall Bucklin, IV, Northamptonshire (GB); Stephen Ronald Berry, Greater London (GB); Maury David Shenk, Greater London (GB)

Correspondence Address: SUTHERLAND ASBILL & BRENNAN LLP, 999 PEACHTREE STREET, N.E., ATLANTA, GA, 30309, US

(73) Assignee: TG SUPPORT LIMITED, Radstock (GB)

(21) Appl. No.: 12/665,513

(22) PCT Filed: Jun. 18, 2008
(86) PCT No.: PCT/GB08/02083

§ 371 Date: Dec. 18, 2009

(30) Foreign Application Priority Data
Jun. 20, 2007 (GB) 0712022.3

(51) Int. Cl. H04K 1/00

(52) U.S. Cl. 380/270; 380/255

(57) ABSTRACT

Systems and methods of making secure communications in a communications network comprising a user device (2) connectable to the network (12) and comprising encryption/decryption means (8) operative after connection, a recipient device (4) is connectable to the user device via an intermediary device (10) having an intermediary contact number and complimentary encryption/decryption means (8) to the user device encryption/decryption means; in use, when the user device connects to the intermediary device using the intermediary contact number, the intermediary device securely obtains a recipient contact number and enables encrypted connection at least between the user and server (10).

### FIELD OF THE INVENTION

The present invention concerns communication systems. In particular the invention relates to encrypted communication systems whereby the communications link is always at least partially encrypted and recipient contact numbers are kept secret.

### BACKGROUND

Communication links such as those made on mobile or landline phones between a user and a recipient are usually initiated by the user dialling the real contact number of the desired recipient.

It may be required in certain circumstances to send voice or data information to one or more recipients via secure communication links as standard ‘open’ communications may be intercepted by unwanted parties. Such a situation may arise when a mobile phone user is travelling in a country where third parties may wish to ‘spy on the users’ communications. The desirable characteristics of secure communications links include both data content and contact number anonymity. To facilitate secure communication links, data or voice calls are often encrypted. Standard encryption systems work on the principle of key sharing whereby the communication contents are coded upon transmission and decoded after reception using a key shared between the user device and recipient device.

To facilitate encryption in the above systems, both the user and the recipient necessarily require means for encryption and decryption. If a user wants to contact a recipient device without such encryption means, the whole communication link must be made using standard open communications which are subject to interception. Additionally, for mobile phone systems, the recipient numbers are often stored on the mobile phone in a phone list accessible by any user of the phone. Even if a phone call is made using encrypted communications, a security threat remains if the mobile device is stolen. In such a circumstance, the thief may be able to gain access to the recipient contact numbers stored on the phone memory. This situation may pose a significant problem when the recipient contact numbers themselves are intended to be kept confidential.

### PRIOR ART

Several techniques and systems exist that facilitate encrypted communications, also systems exist that protect a phone number. Existing examples of both systems are described as follows.

An example of an existing secure number system can be found at the website https://www.flextel.ltd.uk/cgi-bin/secure.sh. Here, a user of the system chooses a number from a list of phone numbers that are not attached to any landline, mobile or physical location. The user affiliates this chosen number to the actual existing phone number that the user wants to receive calls on, for example a landline or mobile number. A chosen number sits in front and protects the existing number. The chosen number is an unchanging number that allows the user to receive incoming calls at any normal telephone wherever the user may be. In this secure number system however, a third party may still be able to intercept and spy on the call content.

An example of an existing technology facilitating an encrypted communication system can be found at the website http://www.tripleton.com/product_security_T301B.htm. The website describes a mobile phone capable of making secure calls to and from mobile phones or other devices such as landlines equipped with compatible encryption technology such as that described in http://www.tripleton.com/product_security_LineCrypt_I_plus.htm. In this system, to make secure communications, the mobile or landline devices require the connecting recipient device to have compatible encryption technology. The number used to initiate the call is the same number used to dial the recipient device.

It is desirable in secure communications to encrypt the content of a communication and also to protect the identity of the real number of the caller and/or the recipient receiving the call.

### OBJECT OF THE INVENTION

It is an object of the present invention to provide a secure communications system wherein communication is encrypted at least between a user device and an intermediary device, regardless of whether or not a recipient device has access to compatible encryption technology. Another object of the present invention is to provide recipient contact number anonymity at least between the user device and the intermediary.

### STATEMENT OF INVENTION

According to the present invention, a secure communication system, includes a communications network; a user device connectable to the network; a recipient device connectable to the network and having a recipient contact number; encryption/decryption means in the user device and operative after connection; and an intermediary device connectable to the network having an intermediary contact number and complimentary encryption/decryption means to the user device encryption/decryption means; the intermediary device is operative to connect to the user device therefrom a communication initiated using the intermediary contact number, enable the encryption/decryption means in the intermediary device, securely obtain a recipient contact number using a communication made to the intermediary device by the user device, and enable connection between the user and recipient devices.

Only the initial contact between the user and the intermediary device is a standard ‘open’ communication, all other communications including the recipient contact number are encrypted, at least, from the user device to the intermediary device and irrespective of whether the recipient device comprises means for encryption/decryption. An encrypted or open communication link exists between the intermediary device and the recipient device.

The secure communications system may further include a caller device, the user device having a user contact number, the intermediary device being further operative to connect to the caller device upon request therefrom a communication initiated using the intermediary contact number, securely obtain a user contact number from a communication made to the intermediary device by the caller device and enable an encrypted connection between the intermediary device and user device.

Also according to the present invention is a method of making secure communications in a communications network having a user device connectable to the network, a recipient device connectable to the network and having a recipient contact number, an encryption/decryption means in the user device operative after connection; comprising connecting an intermediary device to the network, providing the intermediary device with an intermediary contact number and complimentary encryption/decryption means to the user device encryption/decryption means and operating the intermediary device to connect to the user device upon a call therefrom initiated using the intermediary contact number, enabling the encryption/decryption means in the intermediary device, securely obtaining a recipient contact number using a communication made to the intermediary device from the user device and enabling connection between the user and recipient devices.

In a preferred embodiment, the intermediary device is a server comprising a database operative to store and concatenate one or more recipient contact numbers with one or more dummy contact numbers and/or recipient identifiers, the server further being operative to receive the dummy contact number or recipient identifier from the user device, obtain a concatenated recipient contact number from the database and enable connection between the user device and the recipient device associated with the concatenated recipient contact number. The present invention additionally overcomes the above recipient number security risk by allowing the real recipient numbers to be stored on the server rather than on the user device itself.

According to a first embodiment of the present invention the dummy contact numbers are unencrypted server contact numbers, the recipient contact number being obtained from the dummy contact number.

According to a second embodiment of the present invention the recipient contact numbers are encrypted and obtained from the user device.

According to a third embodiment of the present invention the dummy contact number or recipient identifier is encrypted and obtained from the user device.

The server may receive the dummy contact number, recipient contact number or recipient identifier by a vocal command. In this case, the server comprises voice recognition technology operating in use to obtain the recipient contact number or the dummy contact number or the recipient identifier from the vocal command.

The user device and/or recipient device and/or caller device may be; a wireless phone, and/or a non-wireless phone, and/or, any other communications device utilizing electronic/electromagnetic means.

The user device preferably comprises network communication equipment, a memory unit, a processor unit, encryption technology, control software and optionally voice recognition technology, the user device being operative to; connect to the server upon request thereto, enable the encryption means and provide dummy contact numbers, recipient identifiers or recipient contact numbers to the server.

The intermediary device for the system comprises a memory unit, a processor unit, network communication equipment, a database, encryption technology and optionally voice recognition technology. The database of the intermediary device comprises a user group table comprising user contact numbers and, optionally, a recipient group table comprising recipient contact numbers.

Further features of the invention are as set out in the claims and are exemplified in the following illustrative description with reference to the drawings.

### BRIEF DESCRIPTION OF THE DRAWINGS

The above and further features of the present invention are described with reference to the Drawings, wherein:—

FIG. 1 is a schematic diagram, illustrating part-way connectivity according to the present invention;

FIG. 2 is a flow diagram for a first embodiment of the present invention;

FIG. 3 is a flow diagram for a second embodiment of the present invention;

FIG. 4 is a flow diagram for a third embodiment of the present invention;

FIG. 5 is a schematic diagram, illustrating full-way connectivity of the present invention;

FIG. 6 is a schematic diagram illustrating components comprised within the user device;

and,

FIG. 7 is a schematic diagram illustrating components comprised within the intermediary device.

### DETAILED DESCRIPTION

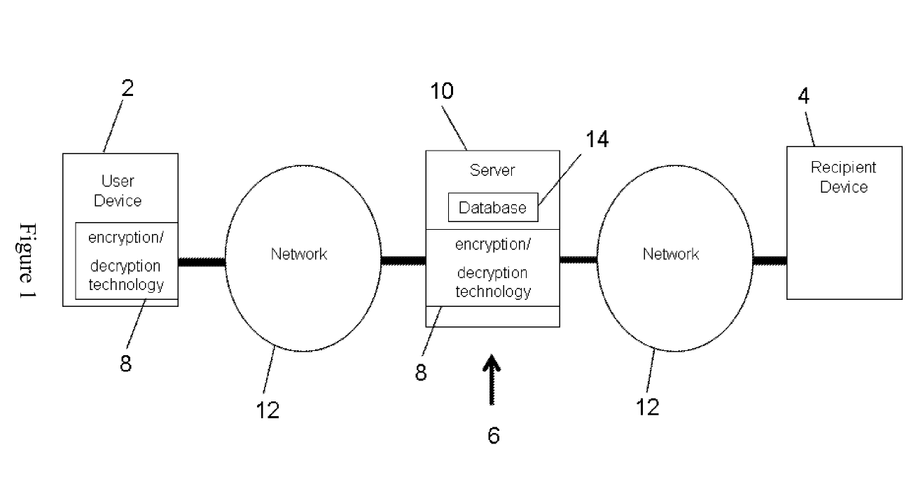

It is desirable that a user may use an encrypting communication device 2 for secure communication with a recipient device 4 by either directly dialling the recipient contact number, as per the current state of the art, or by utilizing the system 6 and methods of the present invention. In accordance with the present invention, the user of the user device 2 is provided with an option of making a communication to a recipient with at least a part-way secure connection to the recipient device 4 regardless of whether of not the recipient device 4 comprises hardware or software to enable secure communications. Secure communications are realized using encrypted means such as encryption/decryption technology 8 embodied in hardware and/or software. The system 6, as shown in FIG. 1 requires that the user makes initial communication with an intermediary device such as a server 10 using a server contact number. A server 10 may also be referred to as a central hub and would preferably be located at a switching centre. There may be more than one switching centre, each housing one or more servers 10 and server contact numbers may be preferentially routed to any one of these centres. The user device 2, as shown in FIG. 1, comprises or has access to encryption technology 8 which is used to make a secure connection to the server 10. Preferably the user device 2 is a mobile phone with the encryption/decryption technology 8 built-in, although any communication device provided with add-on encryption/decryption technology 8 could be used.

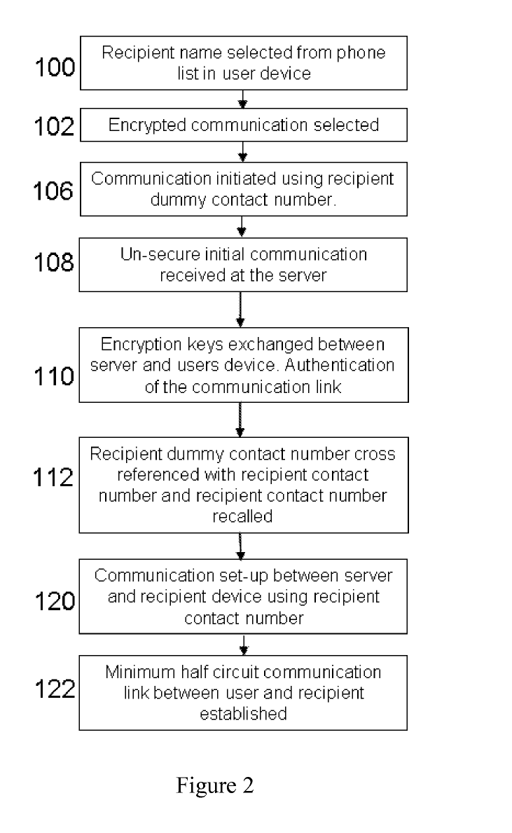

The server 10, as shown in FIG. 1, comprises, or has access to, encryption/decryption technology 8 that is compatible with that of the user device 2. The user may make contact with a recipient device 4 using the system 6 by a number of methods, three of which are embodied in the flow diagrams of FIGS. 2 to 4. In each method the recipient name is selected 100 together with the requirement for an encrypted communication 102 at the user device 2. The user device 2 then dials a number that is not the real recipient contact number. The dialled number is a server number that routes to and is recognizable by the server 10. By dialling the server contact number, the recipient contact number remains a secret. The only contact number a spying, or otherwise unwanted party may ascertain in this initial open communication is the server contact number. When the open initial communication is received 108 at the server 10, a communication channel is opened. The network 12 handling the initial communication routes the call to the server 10 and additionally provides the server 10 with the contact number of the device which made the call. The server 10 then cross references this user device contact number with a list of user contact numbers registered on a database 14 by the system 6. Such a number may be located in a user group table on the database 14. If the number is successfully verified to a registered user of the system 6, the communication is answered and the encryption steps of key exchange and authorisation 110 then take place to set-up an encrypted communication channel between the user device 2 and the server 10.

The server 10 securely obtains a recipient contact number according to any of the embodiments described in this application, and then establishes an ongoing communication link with the recipient device 4, using this recipient contact number 120 to complete the full-way communication link. The minimum, part-way encrypted link 122 from the user device 2 to the server 10 as shown in FIG. 1 thus protects both the call content and the recipient contact number. This link is made every time the user utilises the system 6 of the present invention, regardless of whether encryption technology available to the recipient device 4. The communication link between the server 10 and the recipient device 4 may also encompass security aspects such as encryption, or alternatively, the communication between the server 10 and recipient device 4 may be accomplished using conventional means such as using a standard service on a PSTN (Public Switched Telephone Network).

The present invention thus gives the user the flexibility of calling any recipient number available on conventional accessible networks 12 with the added feature of the first part of the communication circuit between the user device and the server being securely encrypted. This is particularly advantageous when the user is located in territories where security threats exist.

The server 10 may securely obtain the desired recipient contact number by different methods. Each method however is similar in that the recipient contact number is not used to make the initial call to the server 10. Each method is further described in the following preferred embodiments.

In the first embodiment, the method of which is represented by the flow diagram in FIG. 2, all the information required from the user for making the entire connection between the user device 2 and recipient device 4 is contained in the initial open call to the server 10. The user is provided with a set of server contact numbers, each uniquely associated with a recipient contact number. Each server contact number is a dummy contact number for a recipient. Preferably one dummy contact number is associated with one recipient contact number although multiple dummy contact numbers may be associated with a single recipient contact number if so desired. The dummy contact numbers are all routed to the server 10 and are used to initiate the unsecured communication 106 between the user device 2 and the server 10. The dummy contact numbers may be kept in personal possession by the user but are preferably stored on the user device 2. The recipient contact numbers are not kept on the user device 2. Upon establishment of the secure communication between the user device 2 and the server 10, the server 10 automatically associates the dialled dummy contact number with the recipient contact number. The recipient contact numbers are preferably kept on recipient group table on a database 14 accessible by the server 10 wherein the database 14 cross references and concatenates the dummy contact number to recall the recipient contact number 112. Once the recipient contact number is recalled, the server 10 then causes the communication to be routed to the recipient device 4 such that the user device 2 and recipient device 4 are then connected.

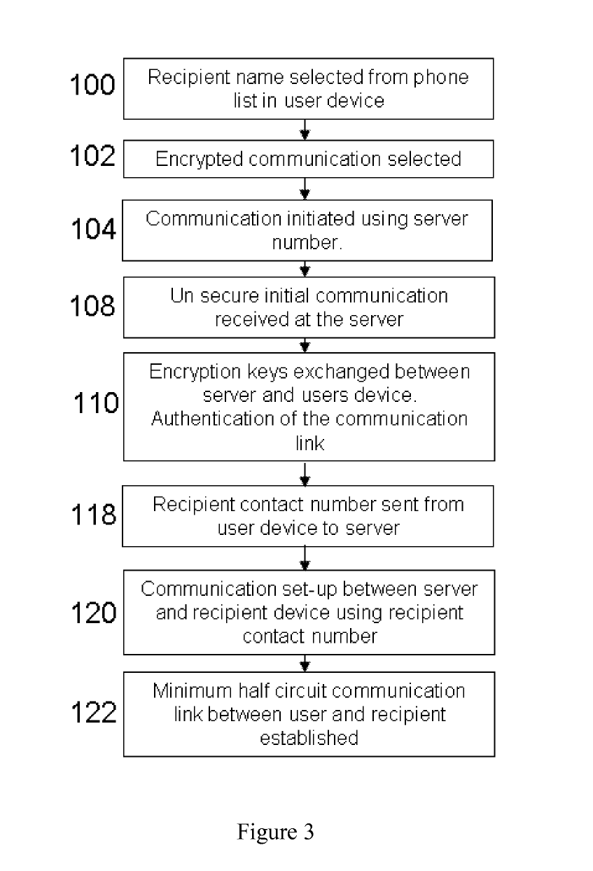

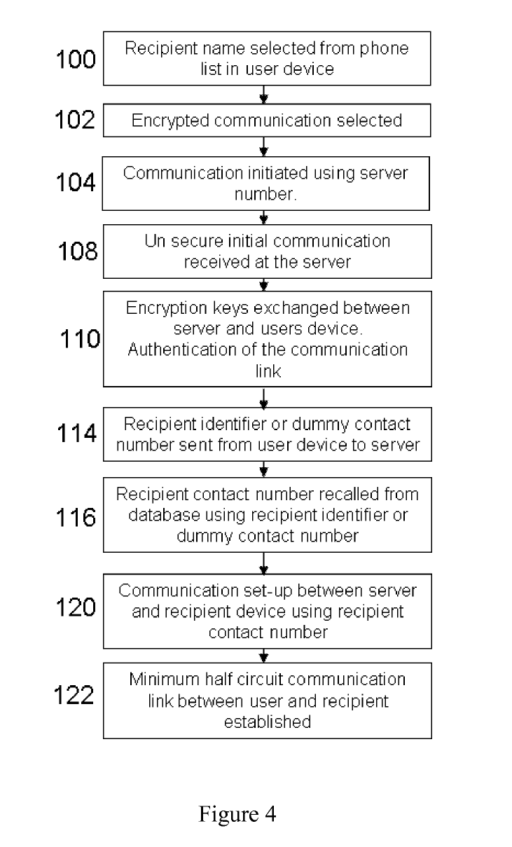

In the second and third embodiments, the methods of which are represented in the flow diagrams of FIGS. 3 and 4 respectively, the user is provided with one or more server contact numbers. These are preferably toll-free numbers that connect to a switching centre and are used to make the initial connection to the server 10. The server contact numbers in these embodiments are not associated with individual recipient contact numbers. The server numbers may be a user specific dialling code to the server 10 that is not stored on the user device 2 but kept in personal possession by the user such that if the user device 2 is stolen, only the user will be able to make calls. Once secure connection has been established by exchanging encryption keys and authenticating the link 110, the user device 2 then sends to the server 10 details of the recipient contact number that the user wishes to make contact with. This is accomplished in the second embodiment by dialling the recipient contact number on the user device 2 and sending it the server 118. Alternatively, according to the third embodiment, the user may dial-in a recipient identifier or a dummy contact number 114. The recipient identifier is a code directing the server 10 to a particular location on a recipient group table on a database 14 to recall the recipient contact number 116. Instead of a recipient identifier being used in the third embodiment, the user device 2 may alternatively dial a dummy contact number, whereby the server 10 associates the dummy contact number with the recipient contact number on a database 14 and recalls the concatenated recipient contact number 116.

Alternatively in the second and third above embodiments, the user may issue a vocal command through the user device 2 corresponding to the recipient that the user wishes to make contact with. This vocal command may be a recipient name or number, which the server 10, using voice recognition technology, then obtains the recipient contact number or the dummy contact number or the recipient identifier. Additionally the vocal command may also be used to verify the identity of the user using the voice recognition technology. In both the second and third embodiments, once the recipient contact number is recalled 116, the server 10 then causes the communication to be routed to the recipient device 4 using the recipient contact number 120 such that the user device 2 and recipient device 4 are then connected.

In all the above preferred embodiments, voice recognition technology may also be included within the user device to further implement identity verification. Voice recognition technology on the user device may also be used to concatenate the vocal command by the user to a recipient name, recipient contact number, recipient identifier or dummy contact number, from which the user device implements the above preferred embodiments of the present invention.

In all the above preferred embodiments, part-way encryption 122 between the user device 2 and server 10 is provided, regardless of any encryption technology 8 of the recipient device 4.

When a communication is intended from a third party or a ‘caller’ to the user, the caller may optionally dial, on a caller device, the user contact number or a user dummy number associated with the user contact number. If the user contact number is dialled, the communication is connected through routes other than the system 6. If however the user dummy number is dialled, the network 12 handling this initial communication, such as a PSTN, recognises the user dummy number as being affiliated to the system 6 and routes the call to the server 10. This first initial connection to the server 10 may be a conventional open connection or an encrypted connection depending on the existence and compatibility of the encryption technology 8 between the server 10 and the caller device.

Once this initial connection from the caller is established, the server 10 then cross references the user dummy number with the associated user contact number. The user dummy number is the number associated by the system 6 to the user device 2 that is not the real user contact number. The server 10 then dials the concatenated user contact number and makes an encrypted connection with the user device 2, thus connecting the caller device to the user device 2. In this manner, the identity of the user contact number of the user device 2 is secure in the initial communication between the caller device and the server 10. The system 6 still provides at least part-way encryption between the server 10 and the user device 2 regardless of the initial communication method between the caller device and the server 10.

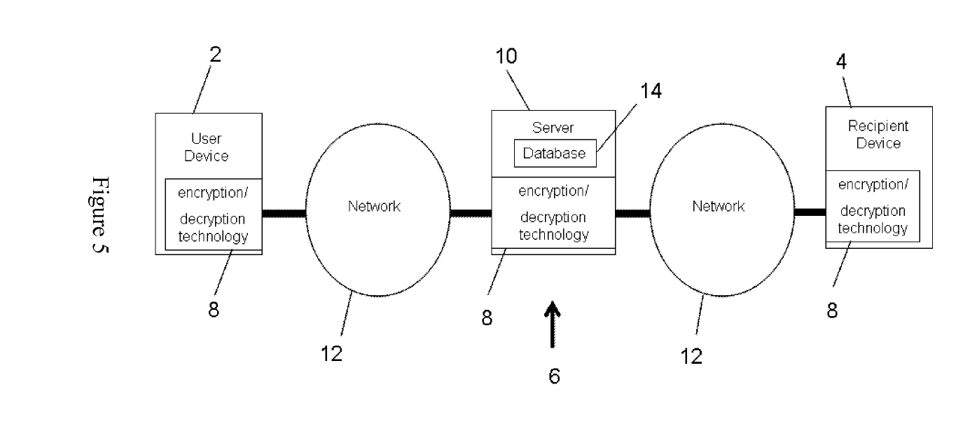

FIG. 5 illustrates a full-way encryption embodiment of the present invention, wherein an encryption link 8 is provided between the server 10 and the recipient device 4. The server-recipient encryption technology need not be the same as the user-server encryption technology; provided the server is equipped with the appropriate encryption technologies and the respective recipient encryption technology is identified by the server with real recipient contact number. Indeed it is an inventive feature of the present invention that the system permits of the use and automatic selection of differing encryption technologies between user and recipient.

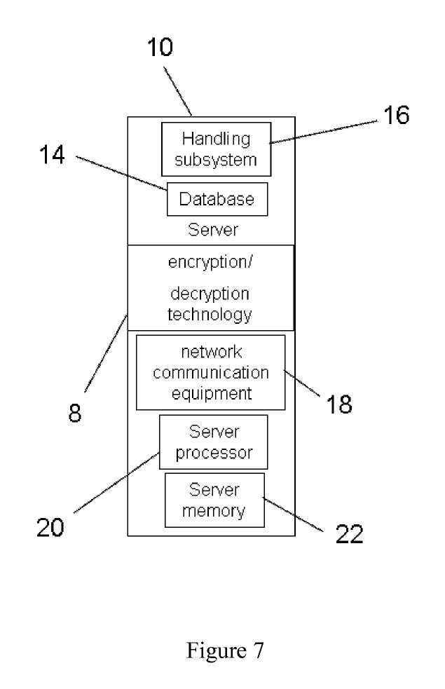

The system 6 may further comprise a call handling subsystem 16 (FIG. 7) which is accessible by or incorporated within the server 10. The handling subsystem 16 is composed of hardware and/or software that operates to perform a number of functions associated with the communication facilities of the system 6. One preferred function is to maintain a connection to the caller or user whilst the system 6 is carrying out any of the aspects of the present invention such as recalling a user contact number, recalling a recipient contact number, enabling an encrypted communication or decrypting an encrypted communication. Whilst the connection is being maintained, the handling subsystem may send a connecting tone or another audible sound to the user. The handling subsystem 16 may also include hardware and/or software to implement filtering of incoming communications from undesirable sources. The handling subsystem 16 may further provide services such as call waiting, voice messaging and any other suitable communications service.

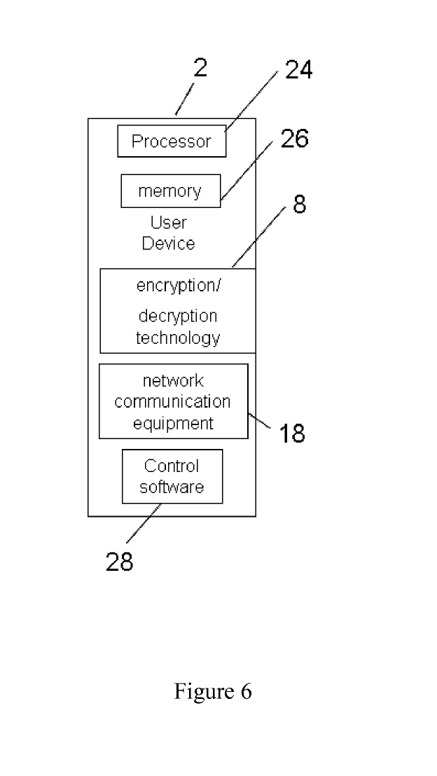

A user device 2 as shown in FIG. 6 of the present invention is preferably a mobile phone comprising network communication equipment 18 and internal hardware encryption technology 8 compatible with the encryption technology 8 accessible by the server 10. The user device 2 also comprises hardware and a software control system 28 that operate to facilitate the methods of the present invention. Such hardware includes a processor 24 and a memory 26 unit. In a preferred embodiment of the user device 2, the recipient contact numbers, dummy contact numbers associated with the recipient, or recipient identifiers are stored securely on the memory unit 26 and are only accessible to view via a password system. By having the recipient contact numbers unavailable for viewing with general use of the phone, the phone additionally provides further contact number anonymity for circumstances where the user device 2 is operational and in the possession of an unwanted third party.

In use, as shown in FIGS. 2 to 4, when a user desires to communicate with a particular recipient, the user scrolls through and selects 100 the recipient name from a list in the user device 2 or alternatively selects the recipient by voice activation. In either case, the recipient contact numbers, dummy contact numbers associated with the recipient or recipient identifiers do not appear or are made available to the user. The number or identifier associated with the chosen name is recalled from the memory 26 and is held in the memory 26 or a further buffer. The user then has an option of making the call using encryption or by conventional open communications. When the command or button is activated that signifies the communication to be initiated via encryption 102, the server contact number 104 or dummy contact number 106 is dialled according to the different embodiments of the invention. An open initial communication is then received 108 at the server 10. The software control system 28 acts to perform the steps required to initiate and establish the encrypted communication of the present invention. These steps include making a call using a server contact number or dummy contact number, sending and receiving encryption keys and authorising the communication link 110, sending the recipient contact number 118 or a dummy contact number or a recipient identifier 114 to the server 10. The software control system may also act to automatically choose an encrypted communication when certain recipients are chosen to be contacted by the user. This ensures that recipients, for whom communication security is important, do not get accidentally contacted by the user using conventional open communication routes.

The server 10 of the present invention, as shown in FIG. 7 comprises network communication equipment 18, a server processor unit 20 and server memory unit 22 as well as the encryption technology 8 required to encrypt and decrypt communications to and from the user device 2, and optionally, the recipient device 4. The server 10 preferably comprises a built-in database 14 comprising a number of group tables containing user and recipient lists and relevant recipient contact details, including the recipient contact numbers that are provided by the user. The recipient contact numbers may be associated with one or more dummy contact numbers according to one embodiment of the present invention.

The recipient device 4 may also encompass the encryption/decryption technology 8 and other features of the user device 2 of the system 6 as shown in FIG. 5. In such a circumstance the server 10 makes an encrypted communication with the recipient device 4 by dialling the recipient contact number. The network 12 handling the server 10 to recipient communication routes the call to the recipient and additionally provides the recipient device 4 with the contact number of the server 10. The recipient device 4 subsequently accepts the call and exchanges encryption keys with the server 10 and authorizes the communication link such that a full way encrypted communication link then exists between the user device 2 and the recipient device 4.

1-22. (canceled)

23. A secure communication system, including:
I) a communications network;
II) a user device connectable to the network;
III) a recipient device connectable to the network and having a recipient contact number;
IV) encryption/decryption means in the user device and operative after connection,
V) an intermediary device connectable to the network and:
i) having an intermediary contact number,
ii) having complimentary encryption/decryption means to the user device encryption/decryption means,
and,
iii) being operative to:
a) connect to the user device therefrom a communication initiated using the intermediary contact number,
b) enable the encryption/decryption means in the intermediary device,
c) securely obtain a recipient contact number using a communication made to the intermediary device by the user device,
and,
d) enable connection between the user and recipient devices.

24. The secure communications system in claim 23, wherein an encrypted or open communication link exists between the intermediary device and the recipient device.

25. The secure communication system in claim 23, wherein the intermediary device is a server comprising a database operative to store and concatenate one or more recipient contact numbers with one or more dummy contact numbers and/or recipient identifiers, the server further operative to:
I) receive the dummy contact number or recipient identifier from the user device,
II) obtain a concatenated recipient contact number from the database,
and,
III) enable connection between the user device and the recipient device associated with the concatenated recipient contact number.

26. The secure communications system in claim 23, further comprising a caller device, the user device having a user contact number, the intermediary device being further operative to:
I) connect to the caller device therefrom a communication initiated using the intermediary contact number,
II) securely obtain a user contact number from a communication made to the intermediary device by the caller device,
and,
III) enable an encrypted connection between the intermediary device and user device.

27. The secure communication system in claim 25, the server comprising a database operative to store and concatenate one or more user dummy numbers with one or more user contact numbers, the server further being operative to:
I) receive a user dummy number from the caller device,
II) obtain a concatenated user contact number from the database,
and,
III) enable connection between the caller device and the user device associated with the user contact number.

28. A method of making secure communications in a communications network having a user device connectable to the network, a recipient device connectable to the network and having a recipient contact number, encryption/decryption means in the user device operative after connection; the method comprising:
I) connecting an intermediary device to the network;
II) providing the intermediary device with an intermediary contact number and complimentary encryption/decryption means to the user device encryption/decryption means;
III) operating the intermediary device to connect to the user device upon a call therefrom initiated using the intermediary contact number,
IV) enabling the encryption/decryption means in the intermediary device;
V) securely obtaining a recipient contact number using a communication made to the intermediary device from the user device,
VI) enabling connection between the user and recipient device.

29. The method in claim 28, wherein the intermediary device enables an encrypted or open communication link between the intermediary device and the recipient device.

30. The method in claim 28, wherein the intermediary device is a server comprising a database operating to store and concatenate one or more recipient contact numbers with one or more dummy contact numbers and/or recipient identifiers, the server further operable for:
I) receiving the dummy contact number or recipient identifier from the user device,
II) obtaining a concatenated recipient contact number from the database,
and,
III) enabling the connection between the user device and the recipient device associated with the concatenated recipient contact number.

31. The method in claim 30, wherein the dummy contact numbers are open server contact numbers, the recipient contact number being obtained from the dummy contact number.

32. The method in claim 30, wherein the dummy contact number or recipient identifier is encrypted and obtained from the user device.

33. The method in claim 30, wherein recipient contact numbers are encrypted and obtained from the user device.

34. The method in claim 30, wherein the server receives the dummy contact number or recipient identifier by a vocal command.

35. The method in claim 33, wherein the server receives the recipient contact number by a vocal command.

36. The method in claim 34, wherein the server comprises voice recognition technology operating in use to obtain the recipient contact number or the dummy contact number or the recipient identifier from the vocal command.

37. The method in claim 28, wherein the communications network further comprises a caller device connectable to the network, the user device has a user contact number, the intermediary device further operable for:
I) connecting to the caller device upon a call therefrom initiated using the intermediary contact number,
II) securely obtaining a user contact number using a communication to the intermediary device from the caller device,
and,
III) enabling an encrypted connection between the server and user device.

38. The method in claim 37, wherein the server further comprises a database operating to store and concatenate one or more user dummy numbers with one or more user contact numbers, the server further operable for:
I) receiving a user dummy number from the caller device,
II) obtaining a concatenated user contact number from the database,
and,
III) enabling connection between the caller device and the user device associated with the user contact number.

39. The system in claim 23, wherein the user device and/or recipient device and/or caller device is:
I) a wireless phone;
and/or,
II) a non-wireless phone;
and/or,
III) any other communications device utilizing electronic/electromagnetic means.

40. The method in claim 28, wherein the user device and/or recipient device and/or caller device is:
I) a wireless phone;
and/or,
II) a non-wireless phone;
and/or,
III) any other communications device utilizing electronic/electromagnetic means.

41. A user device as in claim 23, wherein the user device comprises network communication equipment, a memory unit, a processor unit, encryption means, control software, the user device being operative to:
I) connect to the server upon request thereto,
II) enable the encryption means,
and,
III) provide dummy contact numbers, recipient identifiers or recipient contact numbers to the server.

42. The user device in claim 41, further comprising voice recognition technology.

43. An intermediary device for the system in claim 23, comprising a memory unit, a processor unit, network communication equipment, a database, encryption/decryption means.

44. The intermediary device in claim 43, comprising voice recognition technology.

45. The intermediary device in claim 43, the database comprising:
I) a user group table comprising user contact numbers,
and optionally,
II) a recipient group table comprising recipient contact numbers.
